(19) United States
(12) Patent Application Publication
(10) Pub. No.: US 2004/0103809 A1
(43) Pub. Date: Jun. 3, 2004

(54) Printing process

(76) Inventor: Dennis R. Wiese, Efland, NC (US)

Correspondence Address: HARNESS, DICKEY & PIERCE, P.L.C., P.O. BOX 828, BLOOMFIELD HILLS, MI, 48303, US

(21) Appl. No.: 10/720,630

(22) Filed: Nov. 24, 2003

Related U.S. Application Data
(63) Continuation of application No. 09/771,105, filed on Jan. 26, 2001, now abandoned.

(51) Int. Cl. B41F 7/02

(52) U.S. Cl. 101/483

(57) ABSTRACT

The printing apparatus includes a press unit having at least one ink roller and a solvent delivery system. The ink roller has a center print area and, on one end or both ends, a non-print area. The solvent delivery system has an opening through which a suitable tack-reducing solvent for the ink is delivered to the non-print areas of the ink roller. In the printing process, tack-reducing solvent is delivered to the non-print areas of ink rollers of a printing press during operation of the press to keep the rollers free of dried, tacky ink build-up. The process uses a combination of ink and tack-reducing solvent compatible with the ink.

### CROSS-REFERENCE TO RELATED APPLICATIONS

This application is a continuation of U.S. patent application Ser. No. 09/771,105 filed on Jan. 26, 2001. The disclosure of the above application is incorporated herein by reference.

### FIELD OF THE INVENTION

The invention concerns printing methods, in particular a method, apparatus, and ink system for reducing web breaks or paper jamming, especially for high speed printing.

### BACKGROUND OF THE INVENTION

Web offset printing processes are high-speed operations. In web-fed printing, the paper is fed from a continuous roll or web and is pulled through the printing apparatus. Web printing presses take a web of paper from the original roll to a printed, cut, folded, and stacked product. The speed of the press that makes this printing method so useful can, however, be a drawback when something goes wrong, as when the web breaks for one reason or another. When the web breaks, the printing equipment must be stopped and cleared of any paper jams, the cause of the break must be located and corrected, and the web must be re-fed through the printing system again before printing can continue. This process can result in a substantial amount of down time.

One cause of web breaks is the build up of ink at the edges of the web. In general, the width of a paper web does not extend to the edges of the ink rollers and printing surfaces of the printing press (e.g., the plate cylinder, blanket cylinder, impression cylinder, and ink rollers that carry the ink to these cylinders). Ink can accumulate on the surfaces outside of the printing area, called non-print areas, due to the inability of the ink train transfer rollers to locate the ink film only within the print area. Because the ink in the non-print areas does not get transferred to the web, it tends to build up and become tacky as it loses solvent. The collected dried, tacky ink can catch an edge of the web, causing a web break and press down time.

Ink buildup is a problem in other printing methods as well. In lithographic sheetfed printing, for example, ink can build up and become tacky along the ink train in the same way that it does in lithographic web printing. The ink build up gives rise to the same problems of poor printability on the edges and, while there is no web to break, the sheets can become stuck to the surface of the blanket, jamming the press and requiring down time to free the paper and clean the press.

Hoff, U.S. Pat. No. 5,553,546 discusses the ink build up that occurs when the width of the web is less than the width of the blanket cylinders of an offset web press. The '546 patent finds that a normal cleaning cycle does not sufficiently remove the excess ink that builds up between the edge of the web and the edge of the blanket cylinder, which leads to poor print quality and web breaks. To overcome the problem, the '546 patent modifies the tack-reducing cycle to move the web laterally at one-half inch during the tack-reducing cycle, first toward one edge of the blanket cylinder and then toward the other edge, cleans the ink build-up at the edges of the web path over the printing cylinder. This solution, however, is limited to the cleaning cycle. The press operator must observe the ink build-up and initiate the cleaning cycle before a web break occurs, and production is stopped during the cleaning cycle.

Gasparrini et al., U.S. Pat. No. 5,303,652, describes a spray blanket cleaning system that cleans the blanket cylinder during operation of the press by delivering a pressurized mixture of solvent, water, and air to the entire surface of the blanket. While the press continues to run during the cleaning operation, no printing is being done.

Another way that has been tried to prevent ink build up is by using barriers at the edges of the roller non-print areas along with a gelled grease material, called an “open pocket compound,” in the ink reservoir. The gelled grease mixes with the ink but does not form a solution with the ink. This method has not been successful for keeping ink out of the non-print areas and has been problematic because the grease interferes with the print areas. Because the grease mixes with the ink but does not form a solution with the ink, the grease dilutes the ink at the edges of the image, breaking up the printed image. In a similar method, petroleum oil products that are not soluble in the printing ink have been introduced to the non-print areas by gravity feed. The lack of sufficient compatibility with the ink composition and the lack of sufficient control of rate at which the petroleum oil product is delivered produce the same kinds of problems as the gelled grease and make this method unworkable.

Another solution might be to use rollers that are sized to handle a specific paper width in order to minimize the non-print areas at the ends of the rollers. Thus, a narrower web would be printed using narrower print rollers. This method would have no flexibility for printing paper of various widths, however. Further, as a practical matter, it would be expensive to modify commercially available presses in such a way.

It would be desirable to have a way to keep the ink film in the non-print areas of the rollers from drying and becoming tacky in order to prevent poor print quality and web breaks or paper jams.

### SUMMARY OF THE INVENTION

The present invention provides a printing apparatus including a press unit having ink rollers and a solvent delivery system. The ink rollers have a center print area and terminal non-print areas. The solvent delivery system has an opening through which a tack-reducing solvent for the ink is delivered to the non-print area of one of the ink rollers. By the term “tack-reducing solvent” it is meant a true solvent for the ink (i.e., capable of dissolving the binder in the ink vehicle) that is also capable of reducing the tack of the ink.

In another aspect, the invention provides a printing process in which a tack-reducing solvent is delivered to the non-print area of ink rollers of a printing press during operation of the press to keep the ink film on the rollers from drying and becoming tacky or building up. The invention further provides a combination of ink and a tack-reducing solvent for the ink that is used in the process.

The printing apparatus and method of the invention result in significantly reduced downtimes in printing webs or sheets. In addition, the printing apparatus and process of the invention decrease blanket and plate wear, resulting in reduced blanket usage and plate failure.

### BRIEF DESCRIPTION OF THE DRAWINGS

FIG. 1 is a partial system perspective view of a simplified embodiment of the invention showing delivery of the tack-reducing solvent to ends of ink rollers;

FIG. 2 is a side view of an embodiment of an ink train of the invention with a solvent distribution line end; and

FIG. 3 is an elevational view of an ink roller and two solvent distribution line ends of an embodiment of the invention.

### DETAILED DESCRIPTION OF THE INVENTION

Various kinds of printing methods are known, including lithographic printing, flexographic printing, gravure printing, sheetfed printing, and letterpress printing. In general in a web printing process, the web is fed through one or more printing units. For color printing, each printing unit may apply a different color onto the web. The web then may continue through other press equipment a drying or curing unit, a chill roll, and finishing equipment that cuts the web into sheets and optionally folds and sorts the sheets. The web may be (and typically is) printed on both sides. When the web is printed on both sides, each printing unit has opposing blanket cylinders with associated plate cylinders and ink trains, with the web feeding through a nip between the blanket cylinders.

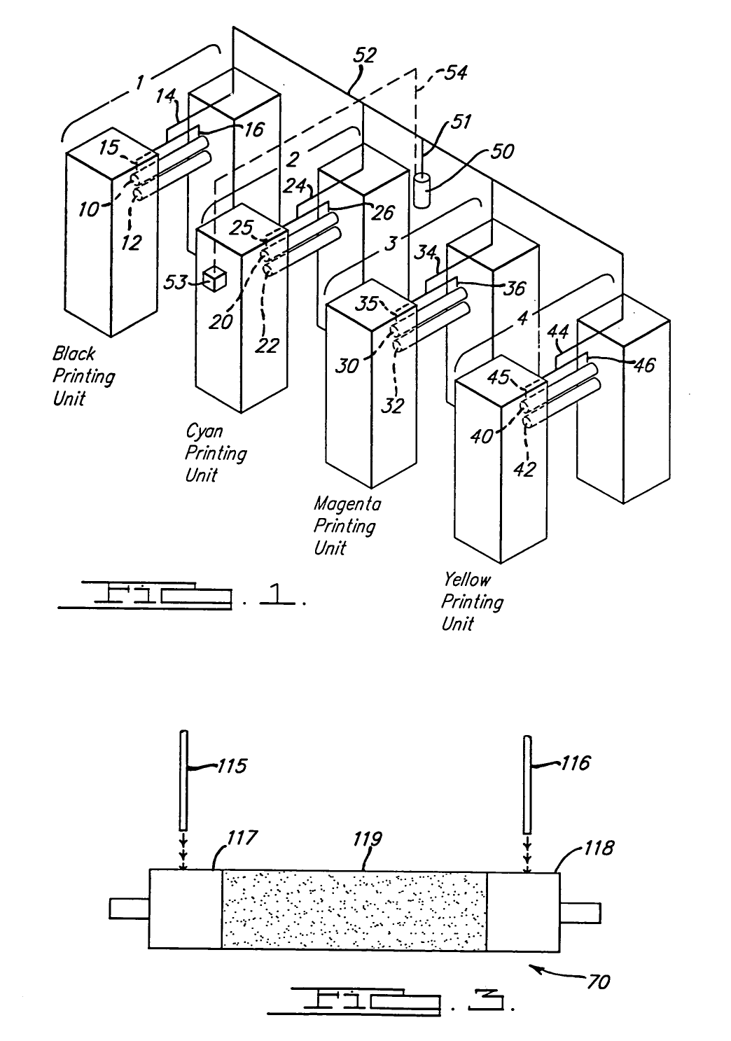

With particular reference now to FIG. 1, a simplified diagram of the invention shows printing units 1, 2, 3, and 4 of a printing press, for a KCMY (black, cyan, magenta, yellow) process, that include pairs of upper ink rollers 10 and 12, 20 and 22, 30 and 32, and 40 and 42. The pairs of ink rollers represent -any two adjacent rollers of an ink train that prints an upper face of a paper web. Rollers 10, 20, 30, and 40 are adjacent to and transfer ink to rollers 12, 22, 32, and 42, respectively. The rollers represent any pair of rollers of the press unit, including the plate cylinder to which the printing plate is attached, the blanket cylinder that receives the inked image from the plate cylinder, and the impression cylinder (if present). The printing units may also have additional upper ink rollers, not shown, between the ink pan and the rollers shown or additional rollers between the rollers shown and the web, and may also have a lower ink roller train, not shown, as necessary for printing a lower face of the web. A solvent pump unit 50, which includes a pump and a reservoir of a tack-reducing solvent, pumps a controlled amount of the tack-reducing solvent through solvent line 51 to solvent distribution line 52.

The rate of solvent delivery of the pump may be controlled using Press Control Logic that is integrated electronically into the press controls. The integration may be accomplished by using a relay logic timer, including controller box 53 having an electrical connection 54 to the solvent pump 50. The rate of solvent delivery may also be controlled using a Programmed Logic Controller (not shown) that is electronically integrated into the press controls. A Programmed Logic Controller may be programmed to automatically increase or decrease the rate of solvent that is pumped when the press controls increase or decrease the printing rate of the press.

The tack-reducing solvent is specially suited to the particular ink being printed, as is explained more fully below. Solvent delivery lines 14, 24, 34, and 44 channel the tack-reducing solvent from the solvent distribution line through openings at ends 15, 16, 25, 26, 35, 36, 45, and 46 to the non-print areas of the rollers. The movements of the ink rollers distribute the tack-reducing solvent across the non-print areas and from the ends of one roller to the ends of an adjacent roller. The tack-reducing solvent keeps the ink from tackifying and building up or agglomerating on the ends of either roller.

The pump of the solvent pump unit 50 may be any kind of pump suitable for pumping solvents. Examples include, without limitation, various reciprocating and rotary pumps, such as air-operated oil pumps. The solvent pump unit also has a reservoir containing the tack-reducing solvent. The solvent reservoir may be monitored and refilled manually when necessary. In a preferred embodiment, however, the solvent reservoir is equipped with a sensor that signals when the reservoir must be refilled. The sensor may be connected to a refill apparatus that is actuated by the sensor to transfer tack-reducing solvent into the reservoir of the solvent pump unit. The refill apparatus may be activated, for example and without limitation, by starting a pump to pump the solvent from a drum, tote, or other container, by opening a valve to let solvent run into the reservoir, and so on. In the case of automatic filling, the refill apparatus may, for instance, be set to deliver a certain amount of solvent or may be turned off through a sensor located at the desired fill point of the reservoir.

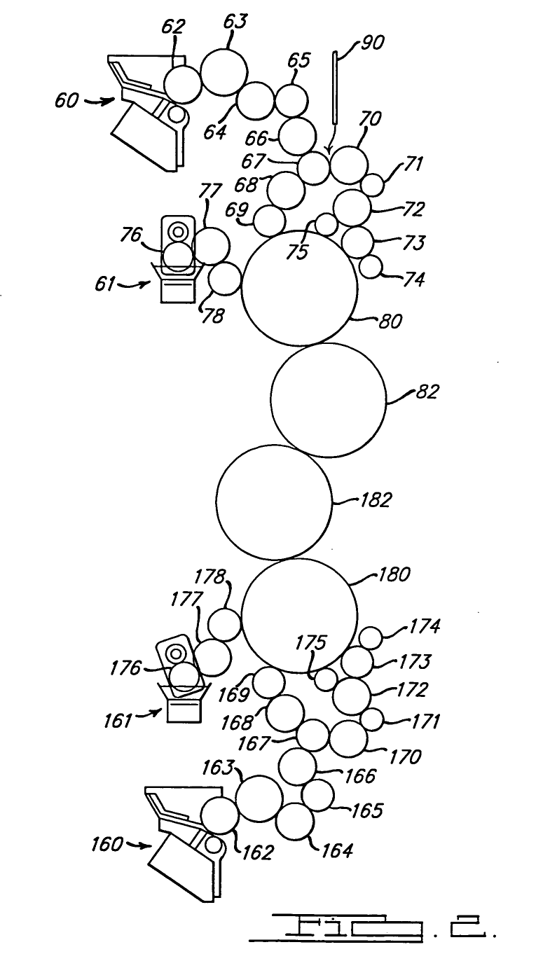

In many cases, for example in lithographic printing where the ink trains can be seven yards (6.4 meters) long or more, it can be more effective and more convenient to introduce the tack-reducing solvent at a point in the ink train before the ends of the plate or blanket cylinders. Introducing the tack-reducing solvent at an earlier point in the ink train may be more effective because it prevents increase in the tack of the ink in non-print areas all along the ink train from the point of introduction of the solvent, which prevents formation of tacky ink build-up that can break off and be slung by the high speed of the rollers to another point that could smudge the print or break the web. Introducing the tack-reducing solvent at an earlier point in the ink train may also be more convenient for positioning tack-reducing solvent delivery lines. FIG. 2 shows one preferred delivery of the tack-reducing solvent through the ink train in a two-fluid offset printing process that prints both the top and the bottom of a web. The ink train includes an upper ink fountain 60 and lower ink fountain 160, both containing ink, and an upper dampener 61 and lower dampener 161, both containing fountain solution. Ink fountain rollers 62 and 162 pick up ink from the ink fountain. Various rollers 63 to 75 and 163 to 175 transfer the ink to the plate cylinders 80 and 180, respectively. Rollers 76-78 and 176-178 transfer the fountain solution to plate cylinders 80 and 180, respectively. The rollers 63 to 75 and 163 to 175 include both vibrator rollers and distributor rollers in a configuration representative of commercial presses of this kind. The ink is finally delivered to the plate cylinders 80 and 180. Printing plates, not shown are clamped around the plate cylinders and provide an inked image that is transferred to the blanket cylinders 82 and 182. The blanket cylinders 82 and 182 are in rolling contact with opposite sides of the web, not shown, and the ink images are offset or transferred to the web. (In a press that prints only one side of the paper, the blanket cylinder is in rolling contact, through the web, with an impression cylinder on the other side of the web.)

The tack-reducing solvent is delivered from solvent distribution line 90 to the nip between rollers 67 and 70. The tack-reducing solvent is preferably delivered dropwise, although the rate of tack-reducing solvent delivery can be varied, for example manually or automatically by action of a Programmed Logic Controller as described above. The tack-reducing solvent is delivered to the end areas of the roller that correspond to non-print regions of the blanket and impression cylinders. Like the ink, the tack-reducing solvent passes upward and downward through the ink train by the contact of adjacent, rotating rollers and through vibrating actions of the rollers. Because the web does not extend to the edges of the blanket cylinders, the tack-reducing solvent can be passed from the edge of the upper blanket cylinder 82 to the edge of the lower blanket cylinder 182, and from there to the edges of the rollers of the lower ink train. It is less likely, however, that tacky ink build up on lower rollers would be transferred up to the web or sheet being printed, particularly for lower rollers further from the paper, and consequently the tack-reducing solvent may not need to be passed to all of the rollers of the lower ink train. In addition to the transfer of ink from roller to roller, the vibrating action of some of the ink train rollers also spreads the tack-reducing solvent over the whole non-print area, preventing dried, tacky ink build-up even at the outermost edges.

FIG. 3 illustrates one embodiment in which the tack-reducing solvent is delivered from the solvent distribution line through openings at ends 115 and 116 to ink roller 70. The arrows show the path that solvent droplets take to non-print regions 117 and 118 of the ink roller 70. The ink roller also has a print region 119 that receives ink from the rollers further back (i.e., closer to the ink tray) in the ink train.

The tack-reducing solvent is typically introduced into the press at a dropwise rate. The delivery rate of the tack-reducing solvent (that is, the amount of solvent per unit time delivered through the opening at the end of the solvent distribution line) depends, for example, on the surface area of ink train that the solvent must wet, the press speed, and the volatility of the tack-reducing solvent. When the tack-reducing solvent is distributed over more rollers, and thus must cover a larger area, the rate of tack-reducing solvent delivery is accordingly higher. The rate of delivery of the tack-reducing solvent may be increased when the tack-reducing solvent is distributed over more rollers. When the tack-reducing solvent is introduced into the ink train further from the web, the rate of delivery of the tack-reducing solvent may be increased to provide sufficient tack-reducing solvent to the non-print areas of the additional rollers. Other conditions under which a higher rate of solvent delivery may be desirable include higher press speeds, using a solvent with a higher evaporation rate (which may be necessary for a particular ink), or changing to a web with a narrower width. In one preferred embodiment, the rate of solvent delivery is preferably from about 1 to about 5 drops per minute, more preferably from about two to about four drops of solvent per minute. In general, it is preferable to introduce a drop of solvent through an aperture in the solvent distribution line to the non-print area every 5 to 60 seconds, more preferably a drop every 10 to 50 seconds, and yet more preferably a drop every 20 to 45 seconds.

The rate of tack-reducing solvent delivery can be adjusted at the beginning of (or during) a press run. If too much solvent is delivered to the non-print edges of the rollers, then the excess solvent may carry over into the print area, causing the print to wash out at the edges of the printing. The rate of solvent delivery should then be reduced. The rate of solvent delivery can be increased if it is observed that ink is building up or becoming tacky in the non-print areas of the rollers.

In an important aspect of the invention, the tack-reducing solvent used in the solvent pump and delivered to the ink train is carefully formulated for the specific ink used in the printing unit. Thus, a specific ink-tack-reducing solvent combination is needed for the method and apparatus of the invention. The tack-reducing solvent must be compatible with the particular ink being printed. The compatibility can be easily determined by applying a small amount of solvent to a film of ink on a nonabsorbent substrate. The solvent should be a solvent for the ink and should be able to lower the tack of the ink. Because the resin systems of inks and graphic arts coatings vary, an appropriate tack-reducing solvent must be selected for each ink or coating. While the tack-reducing solvent need not be a solvent that is present in the ink (for example, the tack-reducing solvent may need to be slower-evaporating), the ink resin should be soluble in the solvent. The particular tack-reducing solvent selected for the ink system depends upon the factors mentioned already, e.g., speed of press, amount of ink train covered, as well as the particular ink composition. While a faster-evaporating tack-reducing solvent may be used in a gravure printing process, which does not have a long ink train and which uses inks containing generally fast-evaporating solvents, a slower evaporating solvent could be more appropriate with cold-set newsinks. When waterborne inks are printed, the tack-reducing solvent that is used may be water and/or a suitable organic cosolvent such as a glycol or glycol ether.

While a common solvent delivery system could be used for all of the print units of a press, as shown in FIG. 1, it is also possible to have multiple solvent delivery systems, each of which services one or more print units. Separate solvent delivery systems might be desirable, for instance, for print units applying spot color inks or for a print unit applying an overprint varnish. because spot color or special color inks and overprint varnishes may have very different kinds of solvent formulations compared to the inks used in other print units of the press.

In general, the solvent distribution lines may have multiple orifices for each end of the rollers of the ink train. The orifices may be connected to the solvent distribution lines through a valve. For example, each end of the solvent distribution lines may have an inner orifice and an outer orifice, each connected to its distribution line through a separate valve. When a wider web is printed on the printing apparatus, the valve for the inner orifice is shut and the valve for the outer orifice is open, so that tack-reducing solvent is delivered only through the outer orifice. When a narrower web is printed, the valve for the inner orifice is open, and the valve for the outer orifice may be open or closed. Thus, it is not necessary to move orifices to accommodate a narrower web.

The tubing for the solvent distribution lines preferably has some flexibility to aid in positioning the orifice. Examples of suitable materials for the tubing include, without limitation, copper, plastic, and brass. The tubing should not be corroded by the solvent. For instance, if the tack-reducing solvent for a waterborne ink includes water, iron pipes should not be used for the solvent distribution lines.

While the invention has been described with particular reference to two-fluid, offset lithographic printing, it should be understood that the invention applies as well to printing with single fluid inks and printing webs by other methods, including web offset, single fluid printing; letterpress; flexographic printing; rotogravure printing; and sheetfed printing. While ink build-up is less of a problem with fewer rollers, for example in gravure or flexographic printing, the invention may still be useful to reduce down time and improve print quality at the edges of the print area. Virtually any printing ink or graphic arts coating could be used, including coldset, heatset, gravure inks, UV curing inks and coatings, and so on.

The process and apparatus of the invention allows lower grades of paper to be used that would otherwise be susceptible to web breaks. While coated papers were less likely to have web breaks on standard presses, coated papers are also more expensive. Super calendered papers have a similar appearance, but are not as strong and are more susceptible to web breaks on standard presses. The printing apparatus and process of the invention make it possible to use the similar-looking but less costly super calendered paper webs.

The invention is illustrated by the following example. The example is merely illustrative and does not in any way limit the scope of the invention as described and claimed. All parts are parts by weight unless otherwise noted.

### EXAMPLE 1

An offset printing apparatus with four print units as shown in FIG. 1 was fitted with a solvent pump and four solvent lines, one line running from the solvent pump to each printing unit. The ink used for each printing unit had a solvent content of 45% by weight that was a 50:50 by weight 520° F. b.p. aliphatic HC solvent and 470° F. b.p. aliphatic HC solvent solvent. The solvent pump was charged with the same 520° F. b.p. aliphatic hydrocarbon solvent as in the ink. An electrical actuator for the solvent pump was attached to the cyan printing unit and set to cause the solvent pump to deliver solvent to each printing unit at a rate of one drop (0.02 grams) every 25 seconds.

The offset print apparatus was used over a period of time to print 71% coated paper web and 29% super calendered paper web at a print rate of approximately 0.56 million impressions (one impression being one whole rotation of the press cylinder) per 24 hours, and the down time for the printing operation was recorded. The measured rate of downtime was 3.6 minutes per million impressions. A 50% decrease in blanket usage was observed over the period of time compared to the same period for Comparative Example A. In addition, less cracking of the aluminum printing plates was observed.

### COMPARATIVE EXAMPLE A

An offset printing apparatus with four print units as shown in FIG. 1 without the solvent pump in operation was used to print only coated paper web at a print rate of approximately 0.56 million impressions per 24 hours, and the down time for the printing operation was recorded. Despite the fact that only the much stronger (and more expensive) coated paper substrate was printed, the rate of down time was 38.5 minutes per million impressions, much greater than for Example 1.

### COMPARATIVE EXAMPLE B

An offset printing apparatus with four print units as shown in FIG. 1 without the solvent pump in operation was used to print only coated paper web at a print rate of approximately 0.56 million impressions per 24 hours, as in Comparative Example A, but this time a gelled grease (Orange Solid Oil, available from Famous Lubricants, Chicago, Ill.) was introduced into both ends of the ink tray corresponding to the non-print areas of the ink tray rollers. The down time for the printing operation was again recorded. Again, despite the fact that only the stronger paper substrate was printed, the rate of down time was 33 minutes per million impressions, much greater than for Example 1.

The invention has been described in detail with reference to preferred embodiments thereof. It should be understood, however, that variations and modifications can be made within the spirit and scope of the invention and of the following claims.

What is claimed is:

1. A method of reducing the incidence of web breakage in web printing or reducing the incidence of sheet jamming in sheetfed printing, comprising steps of:
(a) printing the web or sheets with a printing unit having adjacent, rotating ink rollers, said ink rollers having a central print area and terminal non-print areas, by applying ink to a first ink roller of an upper ink train of ink rollers, the ink being transferred to the print areas and non-print areas of successive adjacent ink rollers and finally printed in an image on the web or sheet substrate;
(b) delivering a sufficient amount of a tack-reducing solvent at a pre-determined rate to the non-print areas of a member selected from the group consisting of a plate cylinder of the upper ink train, a blanket cylinder of the upper ink train, or an ink roller of the upper ink train, so that the tack-reducing solvent is transferred to non-print areas of successive adjacent ink rollers and cylinders reduce the incidence of web breakage or sheet jamming.

2. A method according to claim 1, wherein step (b) is carried out by delivering the tack-reducing solvent to a second ink roller of the upper ink train.

3. A method according to claim 1, wherein the pre-determined rate of step (b) is adjusted according to the printing rate.

4. A method according to claim 1, wherein in step (b) from 1 to about 5 drops per minute of the tack-reducing solvent is delivered.

5. A method according to claim 1, comprising the further steps of:
(c) replacing the paper substrate of step (a) with a second paper substrate having a narrower width;
(d) increasing amount of the tack-reducing solvent delivered in the non-print areas.

6. A method according to claim 1, wherein a solvent line carries the tack-reducing solvent from a reservoir of the tack-reducing solvent and the tack-reducing solvent passes through an aperture in the solvent line onto the non-print areas.

7. A method according to claim 6, comprising further steps of:
(c) replacing the paper substrate of step (a) with a second paper substrate having a narrower width;
(d) closing the aperture in the solvent line and opening a second aperture in the solvent line for solvent to pass onto the non-print areas closer to the edges of the second paper substrate.

8. A method according to claim 1, wherein the tack-reducing solvent is delivered at a rate that does not wash out print at edges of the printing and at a rate that prevents ink build up in non-print areas.

9. A method according to claim 1, wherein the printing is carried out by a method selected from the group consisting of lithographic printing, flexographic printing, letterpress printing, rotogravure printing, and sheetfed printing.

10. A method according to claim 1, wherein the paper substrate is a super calendered paper.

11. A method of reducing incidence of web breakage when printing super calendered paper in a lithographic printing process, comprising a step of delivering to non-print areas of the ink train a solvent that is a tack-reducing solvent for the printing ink, wherein the solvent is delivered at a pre-determined rate sufficient to reduce incidence of web breakage.

12. A method according to claim 11, wherein the rate of solvent delivery is dropwise.

13. A method according to claim 11, wherein from one to five drops of solvent are delivered each minute.

14. A printing apparatus for web printing or sheetfed printing, comprising:
at least one printing unit having adjacent ink rollers, said ink rollers having terminal non-print areas, and
a solvent delivery system for delivering a tack-reducing solvent at an adjustable rate to the non-print areas of at least one ink roller such that the incidence of web breakage or sheet jamming is reduced and such that print at the edges of print areas is not washed out.

15. A printing apparatus according to claim 14, wherein said solvent delivery system comprises a solvent line for moving the solvent to the non-print areas of the at least one ink roller and apertures in the solvent line to deliver the solvent to said non-print areas.

16. A printing apparatus according to claim 15, wherein the solvent delivery system further comprises a reservoir for containing the solvent, from which reservoir the solvent line receives the solvent.

17. A printing apparatus according to claim 16, wherein the solvent delivery system comprises a pump for pumping the solvent from the reservoir.

18. A printing apparatus according to claim 17, wherein the solvent delivery system further comprises a controller for adjusting the rate of delivery of solvent to the non-print area.

19. A printing apparatus according to claim 15, wherein the solvent line has at least two spaced apertures that can be opened and closed each end of said at least one ink roller.
